(19) United States
(12) Patent Application Publication
(10) Pub. No.: US 2004/0189581 A1
(43) Pub. Date: Sep. 30, 2004

(54) Multiline addressing drive method and apparatus for passive matrix liquid crystal, and a liquid crystal panel

(75) Inventors: Norimitsu Sako, Chiba (JP); Hideyuki Kitayama, Chiba (JP)

Correspondence Address: OLIFF & BERRIDGE, PLC, P.O. BOX 19928, ALEXANDRIA, VA, 22320, US

(73) Assignee: KAWASAKI MICROELECTRONICS, INC., Chiba-shi (JP)

(21) Appl. No.: 10/808,369

(22) Filed: Mar. 25, 2004

(30) Foreign Application Priority Data
Mar. 28, 2003 (JP) 2003-090043

(51) Int. Cl. G09G 3/36

(52) U.S. Cl. 345/98

(57) ABSTRACT

The multiline-addressing drive method and apparatus for passive matrix liquid crystal drive simultaneously plural rows of the liquid crystal as one block of rows by using an orthogonal function. The method and apparatus allocate rotated column vectors of plural selection-equivalent orthogonal functions obtained by rotating row vectors of one orthogonal function which is used as a selection pattern for simultaneously selected row electrodes to plural divided selection time periods obtained by dividing a selection time period of one of the simultaneously selected row electrodes, respectively and allow the column vectors of every selection-equivalent orthogonal function to loop back in time series with respect to the above one block. The liquid crystal panel is driven the method. The method and apparatus eliminate COM stripes and bias concentration, both specific to the MLA drive system, to improve the display quality and, in addition, achieve reduction in power consumption and circuit downsizing.

### BACKGROUND OF THE INVENTION

1. Field of the Invention

The present invention relates to a multiline addressing drive method, a multiline addressing drive apparatus for driving passive matrix liquid crystal and a liquid crystal panel.

2. Description of the Related Art

Liquid crystal displays (LCDs) have conventionally been used as a display apparatus for a word processor or a personal computer. Because of their advantages such as easy downsizing, small thickness, and light weight, the LCDs have been more and more frequently used in these days as, for instance, a display of a cellular phone.

Among the LCDs, there exist those of passive matrix type in which so-called twisted nematic type (TN type) or super twisted nematic type (STN type) liquid crystal display elements are driven using no thin-film transistor. As a drive system for such LCDS, a multiline-addressing drive system (MLA drive system) has been proposed, which is, in contrast to former systems of line-sequential scanning type, a multiline simultaneous drive system for simultaneously selecting and driving a plurality of scan lines.

Under the MLA drive system, however, horizontal stripe-like unevenness (brightness unevenness) is generated due to the waveform pattern given to scan electrode lines even if the effective voltage applied to liquid crystal is not changed. The horizontal stripe-like unevenness in brightness is sometimes referred to as common stripes so called “COM stripes” because it is generated in the form of stripes extending in a row electrode (common electrode) direction.

In addition, when the display pattern indicates an all-ON or -OFF representation, the bias voltage applied in a non-selection time period is concentrated at the time period in which the simultaneously selected lines are all scanned with voltage pulses of the same polarity, leading to a possible bias concentration in which the optical response varies to cause the brightness unevenness.

It has been proposed by, for instance, JP 07-072454 A as a means for solving such problems as bias concentration and COM stripes to shift (horizontally and vertically) signal waveforms used for driving liquid crystal.

The horizontal shift disclosed in JP 07-072454 A is carried out in a multiline-selection method as follows: Starting from the top of a display screen, scan electrodes are selected in installments such that a plurality of them are simultaneously selected in each case, and scanned downwardly. On this occasion, the phase of the scanning signal waveforms to be given to the simultaneously selected scan electrodes is so shifted from that of the signal waveforms which were given to the scan electrodes selected just before the relevant ones that, in the case of an all-ON or -OFF representation, the bias voltage applied to liquid crystal in a non-selection time period may not be concentrated at a time period of one-time frame scanning within a ½ cycle but distributed, the bias concentration thus eliminated.

In the vertical shift disclosed in the above document, difference is made between two adjacent cycles in the waveform pattern used for the simultaneously selected lines by replacing the scanning signal waveforms to be given to the simultaneously selected scan electrodes with one another so as to make the lines uniform in frequency with one another and eliminate the horizontal stripe-like unevenness (COM stripes) generated at an interval corresponding to the number of the simultaneously selected lines.

FIG. 13 shows an example of the horizontal shift of driving waveforms. In the case where every four lines are simultaneously selected as shown in FIG. 13, the voltage waveform of scanning signals is set based on the Walsh function and shifted in phase by one whenever a set of four lines is simultaneously selected. In FIG. 13, F₁(t) denotes the scanning signal waveform. In the example as shown, lines are selected four by four and scanned for each set of four sequentially from the top of a matrix panel to the bottom. During a first scan, F₁, F₂, F₃ and F₄ are initially set to +Vᵣ each. Then, F₅, F₆, F₇ and F₈ are shifted in phase by one and set to +Vᵣ, +Vᵣ, −Vᵣ and −Vᵣ, respectively. Such a procedure is repeated as to F₉ and so forth so that the scanning signals shifted in phase sequentially by one are applied to the scan electrodes. On the other hand, the data signals G₁(t), G₂(t) and G₃(t) calculated by performing a product-sum operation are applied to the signal electrodes. In this way, the voltage to be applied to the signal electrodes that used to be concentrated at the first time period of frame scanning is generated whenever the line selection is carried out four times so that the voltage may be distributed uniformly throughout the entire ½ cycle so as to eliminate the difference in contrast due to the display pattern and suppress the brightness unevenness.

FIG. 14 shows an example of the vertical shift of driving waveforms. In the example as shown, F₁, F₂, F₃ and F₄ are initially set in the first half of a first cycle using the Walsh function. In the second half of the first cycle, nothing is carried out but the polarity reversal. Next in a second cycle, the waveform arrangement pattern is modified by the vertical shift, that is to say, the pattern is converted from a combination of W1, W2, W3, and W4 to a combination of W4, W1, W2, and W3. Thus, as seen from FIG. 14, a mixture of frequency components which are different from cycle to cycle is provided with respect to any of F₁, F₂, F₃ and F₄ in order to make the frame response uniform and eliminate the COM stripes.

The problem of brightness unevenness or horizontal stripe-like unevenness, however, still remains in the conventional methods for eliminating bias concentration and COM stripes by the horizontal or vertical shift as above.

To be more specific: Bias concentration periodically occurs in some block of lines or other even though column vectors are updated whenever a block of lines is simultaneously selected. The block with bias concentration is to be displaced for each scan (field), which is inconspicuous if the operating frequency is high enough. If the frequency is rather low, however, it looks as if a block of lines which is bright ran on a screen (or swept the screen) at a cycle corresponding to one display cycle (four fields).

Again, the COM stripes generated in a display cycle last during the cycle even though row vectors are rotated for each display cycle. Although inconspicuous if the operating frequency is high enough, such COM stripes are conspicuous until row vectors are rotated in a next display cycle if the frequency is rather low.

In view of the above former problems, the present invention has a first object of providing a multiline-addressing (MLA) drive method for passive matrix liquid crystal, capable of eliminating the common (COM) stripes and the bias concentration that are specific to an MLA drive system for simultaneously driving a plurality of rows (a block of rows) of passive matrix liquid crystal by using orthogonal functions and, as a result, capable of improving the display quality.

The present invention has a second object of providing a multiline-addressing (MLA) drive apparatus for passive matrix liquid crystal implementing the above multiline-addressing (MLA) drive method for passive matrix liquid crystal.

The present invention has a third object of providing a liquid crystal panel which the above multiline-addressing (MLA) drive method for passive matrix liquid crystal is implemented.

### SUMMARY OF THE INVENTION

In order to attain the first object described above, the first aspect of the present invention provides a multiline addressing drive method for passive matrix liquid crystal by using an orthogonal function to simultaneously drive a plurality of rows of the passive matrix liquid crystal as one block of rows, comprising steps of: allocating rotated column vectors of a plurality of selection-equivalent orthogonal functions obtained by rotating row vectors of one orthogonal function which is used as a selection pattern for simultaneously selected row electrodes to a plurality of divided selection time periods obtained by dividing a selection time period of one of the simultaneously selected row electrodes, respectively; and allowing the column vectors of every the selection-equivalent orthogonal function to loop back in time series with respect to the one block.

In order to attain the first object described above, the second aspect of the present invention provides a multiline addressing drive method for passive matrix liquid crystal by using an orthogonal function to simultaneously drive a plurality of rows of the passive matrix liquid crystal as one block of rows, comprising steps of: scanning column vectors of the orthogonal function in each of a plurality of divided selection time periods obtained by dividing a selection time period of one of simultaneously selected row electrodes to select the column vectors; and rotating the column vectors bitwise in accordance with the divided selection time periods.

It is preferable that the divided selection time periods are smaller in number than the column vectors of the orthogonal function.

It is also preferable that the plurality of selection-equivalent orthogonal functions are equal in number to or smaller in number than the divided selection time periods.

In order to attain the second object described above, the third aspect of the present invention provides a multiline addressing drive apparatus for passive matrix liquid crystal, which drives the liquid crystal by the multiline addressing drive method according to the first or second aspects of the present invention.

In order to attain the third object described above, the fourth aspect of the present invention provides liquid crystal panel driven by the multiline addressing drive method according to the first or second aspects of the present invention.

### BRIEF DESCRIPTION OF THE DRAWINGS

FIG. 1 is a block diagram showing the circuit configuration of an embodiment of the liquid crystal drive apparatus for implementing the multiline-addressing drive method for passive matrix liquid crystal according to the present invention;

FIGS; 2A and 2B are diagrams each showing an example of the orthogonal function of 4×4 used in the first embodiment of the method of the invention and FIG. 2C is a diagram showing an example of the display cycle of the simultaneous drive system for four rows of the first embodiment of the multiline-addressing drive method of the invention;

FIG. 3 is a more detailed version of FIG. 2C;

FIGS. 4A, 4B, 4C, 4D, and 4E are diagrams illustrating as a whole the case where every four rows are simultaneously driven by using the orthogonal function A of FIG. 2A as the row electrode selection pattern by showing the row electrode selection pattern, the display pattern, the result of MLA operation, the column electrode voltage pattern, and the value corresponding to the effective voltage, respectively;

FIGS. 5A, 5B, 5C, 5D, and 5E are diagrams illustrating as a whole the case where every four rows are simultaneously driven by using the orthogonal function B of FIG. 2B as the row electrode selection pattern by showing the row electrode selection pattern, the display pattern, the result of MLA operation, the column electrode voltage pattern, and the value corresponding to the effective voltage, respectively;

FIGS. 6A, 6B, 6C, and 6D are diagrams each showing an example of the orthogonal function of 7×8 used in the second embodiment of the method of the invention;

FIG. 7 is a diagram showing the first half of an example of the display cycle of the simultaneous drive system for seven rows of the second embodiment of the multiline-addressing drive method of the invention;

FIG. 8 is a diagram showing the second half of the example of the display cycle as shown in FIG. 7;

FIGS. 9A, 9B, 9C, 9D, and 9E are diagrams illustrating as a whole the case where every seven rows are simultaneously driven by using the orthogonal function A of FIG. 6A as the row electrode selection pattern by showing the row electrode selection pattern, the display pattern, the result of MLA operation, the column electrode voltage pattern, and the value corresponding to the effective voltage, respectively;

FIGS. 10A, 10B, 10C, 10D, and 10E are diagrams illustrating as a whole the case where every seven rows are simultaneously driven by using the orthogonal function B of FIG. 6B as the row electrode selection pattern by showing the row electrode selection pattern, the display pattern, the result of MLA operation, the column electrode voltage pattern, and the value corresponding to the effective voltage, respectively;

FIGS. 11A, 11B, 11C, 11D, and 11E are diagrams illustrating as a whole the case where every seven rows are simultaneously driven by using the orthogonal function C of FIG. 6C as the row electrode selection pattern by showing the row electrode selection pattern, the display pattern, the result of MLA operation, the column electrode voltage pattern, and the value corresponding to the effective voltage, respectively;

FIGS. 12A, 12B, 12C, 12D, and 12E are diagrams illustrating as a whole the case where every seven rows are simultaneously driven by using the orthogonal function D of FIG. 6D as the row electrode selection pattern by showing the row electrode selection pattern, the display pattern, the result of MLA operation, the column electrode voltage pattern, and the value corresponding to the effective voltage, respectively;

FIG. 13 is a diagram illustrating a multiline simultaneous drive system of a conventional type based on a horizontal shift; and

FIG. 14 is a diagram illustrating a multiline simultaneous drive system of a conventional type based on a vertical shift.

### DETAILED DESCRIPTION OF THE PREFERRED EMBODIMENTS

A multiline-addressing drive method and a multiline-addressing drive apparatus for passive matrix liquid crystal, and a liquid crystal panel according to the first, second and third aspects of the present invention, respectively, will be described below in detail based on the preferred embodiments illustrated in the accompanying drawings.

According to the present invention, in a multiline-addressing (MLA) drive system for simultaneously driving a plurality of rows (a block of rows) of passive matrix liquid crystal by using an orthogonal function, rotated column vectors of a plurality of orthogonal functions (selection-equivalent orthogonal functions) obtained by rotating row vectors of one orthogonal function are allocated to a plurality of divided selection time periods obtained by dividing the selection.time period of one row electrode and the column vectors of every selection-equivalent orthogonal function are allowed to loop back in time series with respect to one block, with the divided selection time periods being smaller in number than the column vectors, so that the COM stripes and the bias concentration, both specific to the MLA drive system, are eliminated and the display quality improved.

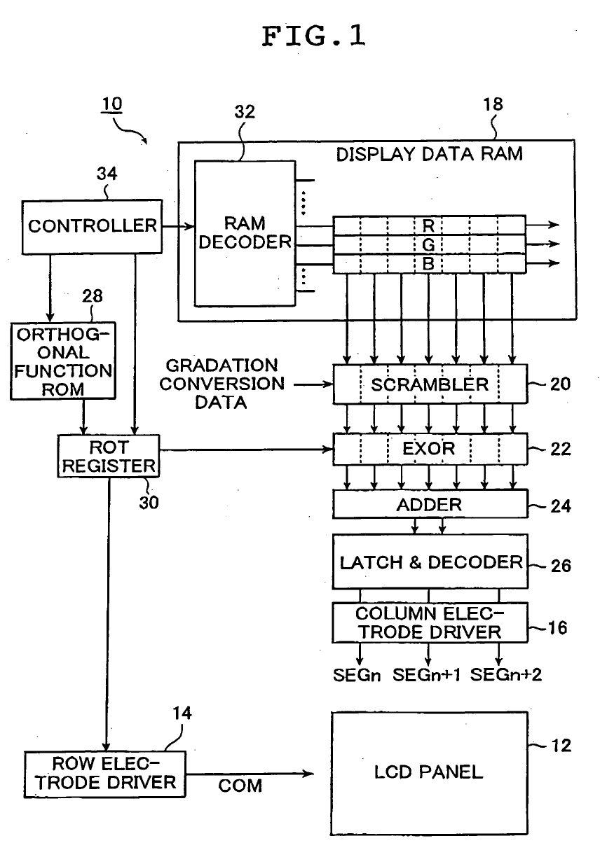

FIG. 1 is a block diagram showing the circuit configuration of an embodiment of the liquid crystal driving apparatus (LCD driver) for implementing the method for driving passive matrix liquid crystal on a multiline-addressing basis according to the present invention. The LCD driver of this embodiment selects and drives a plurality of row electrodes simultaneously.

As shown in FIG. 1, the LCD driver 10 of this embodiment employs an MLA drive system for simultaneously selecting a plurality of row electrodes (common) from among those of an LCD panel 12 to drive them with a predetermined column electrode voltage and comprises a row electrode driver 14, a column electrode driver 16, and a display data RAM (display data memory) 18.

The LCD driver 10 further comprises a scrambler 20, an EXOR gate 22, an adder 24, and a latch & decoder 26. For the gradation representation, the scrambler 20 receives gradation data (gradation conversion data) from a gradation selector (not shown).

An orthogonal function ROM 28 and an ROT register 30 are mounted for the rotation of the row vectors of the orthogonal function giving the selection pattern for simultaneously selected row electrodes. In the orthogonal function ROM 28 is stored the initial values of the column vector of the orthogonal function. The ROT register 30 rotates the bits of the stored initial value of a column vector to send the rotated value to the EXOR gate 22 and the row electrode driver 14. A desired row electrode selection pattern is achieved by such rotation.

The display data RAM 18 is provided with an RAM decoder 32.

Finally, a controller 34 is mounted for controlling each of such components.

Since the colors R, G and B are processed in a time-sharing manner in this embodiment, the scrambler 20, the EXOR gate 22, the adder 24, and the latch & decoder 26 in the LCD driver 10 as shown in FIG. 1 are each only one in number. These components, however, may also be provided for each column (segment) and for each of the colors of R, G and B.

Color (R, G or B) data for a plurality of rows of the LCD 12 which are simultaneously driven are simultaneously outputted from the display data RAM 18 to the scrambler 20. For each data received, the scrambler 20 outputs an ON/OFF signal in accordance with the inputted gradation modification data. Exclusive ORs of the respective ON/OFF signals outputted from the scrambler 20 on one hand, and the corresponding row electrode selection pattern received from the ROT register 30 on the other are obtained by the EXOR gate 22 and added by the adder 24.

The result of addition is fed to the latch & decoder 26, where the voltage level corresponding to the result of addition is selected and outputted to the column electrode driver 16. Then, the LCD 12 is driven by the row electrode driver 14 and the column electrode driver 16.

As described above, an MLA drive system is employed in this embodiment. It is necessary for the avoidance of the phenomenon of frame response variation to employ the MLA drive system which enables an increased number of times of selection per unit time. Since the number of times of selection increases as the number of rows selected at a time is larger, the FLA7 (four-level addressing 7) drive system for simultaneously driving seven rows is preferred. While eight levels of column electrode voltage are generally needed on an MLA drive system for simultaneously driving seven rows, the FLA7 drive system requires only four levels and, accordingly, also has an effect of reducing the frequency at which the column electrode voltage is changed to about ½. The FLA7 drive system is a very effective technique which can meet various market requirements imposed especially on LCD modules for cellular phones, such as multicolored representation, high image quality, moving-image compliance, less power consumption, low price, symmetry, 3-side-free configuration, and one-chip integration.

An example of the simultaneous drive system for four rows using the vector rotation of a 4×4 orthogonal matrix is now described as a first embodiment of the method according to the present invention.

FIG. 2A shows an example of the 4×4 orthogonal matrix expressing an orthogonal function. The matrix A as shown is an orthonormal matrix. More specifically, the product of the matrix A and its transpose A^{t} is an integral multiple of the unit matrix (which being regarded as a scalar matrix), that is to say, AA^{t}=4I (where I is the unit matrix of degree 4).

It is assumed that the first row AC1 of the matrix A is [1, 1, 1, −1], the second row AC2 is [1, −1, −1, −1], the third row AC3 is [1, −1, 1, 1], and the fourth row AC4 is [−1, −1, 1, −1].

FIG. 2B shows a matrix B obtained by shifting (rotating) the rows of the matrix A by one. Specifically, the first row BC1 of the matrix B is identical to the second row AC2 of the matrix A, the second row BC2 to the third row AC3 of the matrix A, the third row BC3 to the fourth row AC4 of the matrix A, and the fourth row BC4 to the first row AC1 of the matrix A.

It should be noted that the displacement or rotation of the rows of an orthogonal matrix does not affect the orthogonality of row vectors.

Hereafter, the orthogonal functions expressed by the orthogonal matrices A and B, respectively, are also denoted by the characters A and B, respectively.

FIG. 2C presents an example of the simultaneous drive system for four rows. It is assumed in this embodiment that the row electrodes are 12 in number and are to be driven in three blocks (BLK1 to BLK3).

As shown in FIG. 2C, one display cycle (for one frame) is completed in four fields. Each of the row selection time periods (1, 2 and 3) is divided into two parts, namely the divided selection time periods 1 and 2.

In the first field as shown FIG. 2C, the column vector AR1 of the orthogonal function A expressed by the orthogonal matrix A is to be applied to the divided selection time period 1 of the row selection time period 1 and the column vector BR2 of the orthogonal function B to the divided selection time period 2.

The column vector AR3 of the orthogonal function A is to be applied to the divided selection time period 1 of the row selection time period 2 and the column vector BR4 of the orthogonal function B to the divided selection time period 2.

Similarly, the column vector AR1 of the orthogonal function A and the column vector BR2 of the orthogonal function B are to be applied to the divided selection time periods 1 and 2 of the row selection time period 3, respectively.

In the second field, the column vector AR3 of the orthogonal function A and the column vector BR4 of the orthogonal function B are to be applied to the divided selection time periods 1 and 2 of the row selection time period 1, respectively; the column vector AR1 of the orthogonal function A and the column vector BR2 of the orthogonal function B to the divided selection time periods 1 and 2 of the row selection time period 2, respectively; and the column vector AR3 of the orthogonal function A and the column vector BR4 of the orthogonal function B to the divided selection time periods 1 and 2 of the row selection time period 3, respectively.

In the third field, the column vector BR1 of the orthogonal function B and the column vector AR2 of the orthogonal function A are to be applied to the divided selection time periods 1 and 2 of the row selection time period 1, respectively; the column vector BR3 of the orthogonal function B and the column vector AR4 of the orthogonal function A to the divided selection time periods 1 and 2 of the row selection time period 2, respectively; and the column vector BR1 of the orthogonal function B and the column vector AR2 of the orthogonal function A to the divided selection time periods 1 and 2 of the row selection time period 3, respectively.

Finally, in the fourth field, the column vector BR3 of the orthogonal function B and the column vector AR4 of the orthogonal function A are to be applied to the divided selection time periods 1 and 2 of the row selection time period 1, respectively; the column vector BR1 of the orthogonal function B and the column vector AR2 of the orthogonal function A to the divided selection time periods 1 and 2 of the row selection time period 2, respectively; and the column vector BR3 of the orthogonal function B and the column vector AR4 of the orthogonal function A to the divided selection time periods 1 and 2 of the row selection time period 3, respectively.

As a result of such setting as described above, with respect to, for instance, the first block BLK1 (of rows 1 to 4), the column vectors (AR1, AR2, AR3 and AR4; or BRi similarly) are rotated, that is to say, each of the column vectors of the orthogonal functions A and B is applied once a cycle.

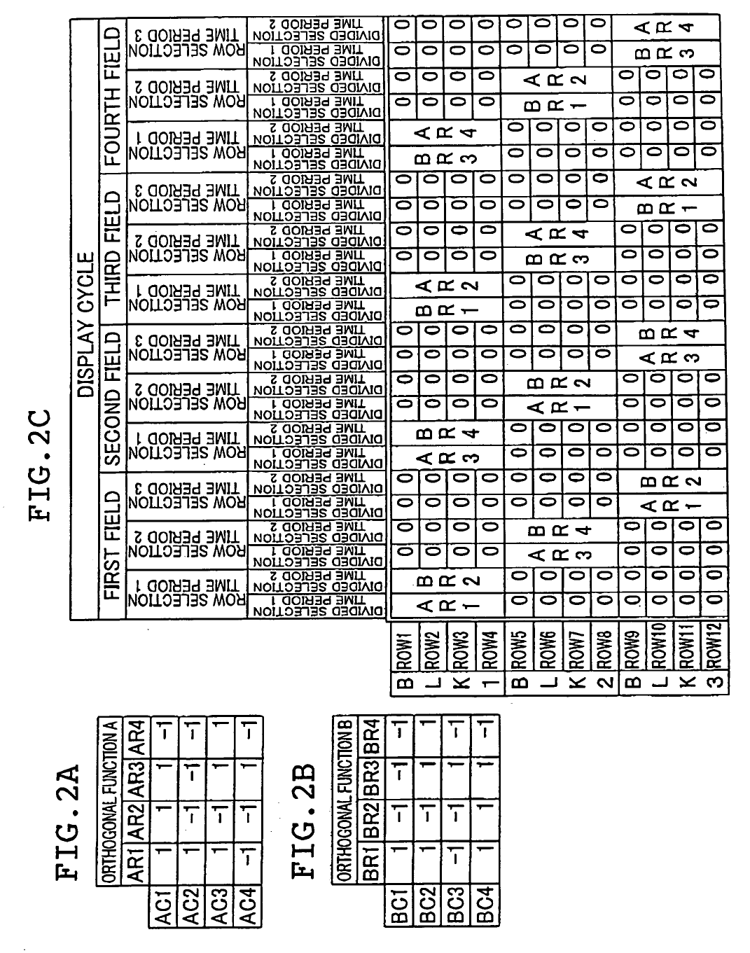

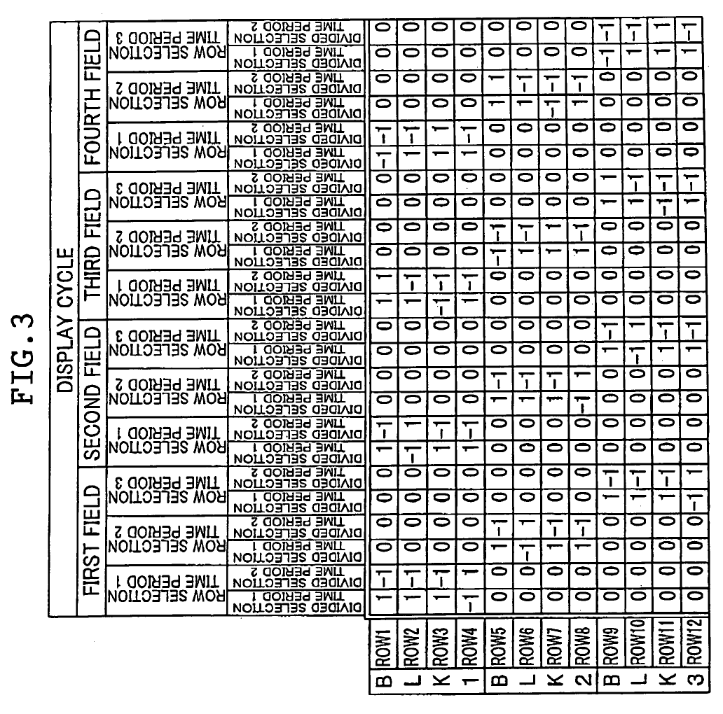

In FIG. 3, the elements of the respective column vectors are specifically shown.

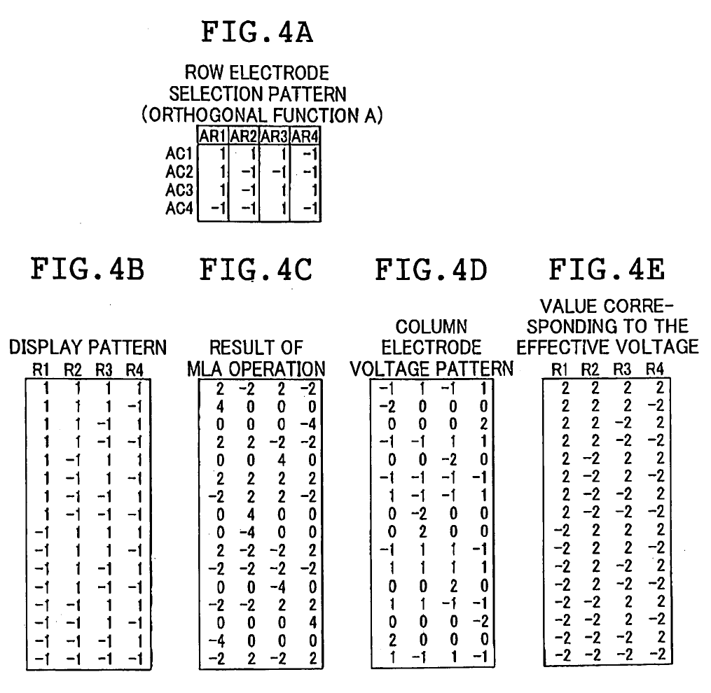

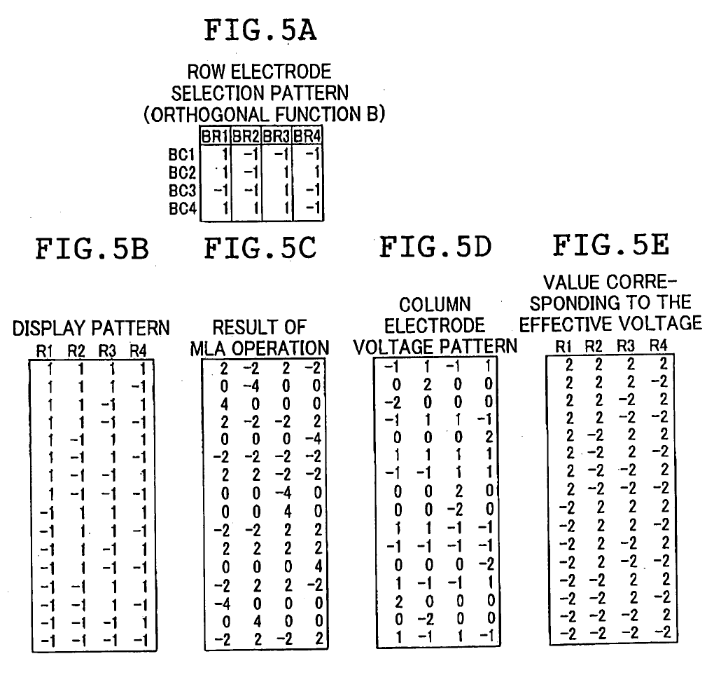

The simultaneous driving of four rows carried out in this embodiment using an orthogonal function of 4×4 is described in more detail. In this respect, FIG. 4 illustrates the case where the orthogonal function A is used as the row electrode selection pattern in this embodiment while FIG. 5 illustrates the case where the orthogonal function B is used as the row electrode selection pattern in this embodiment. The two cases are similar to each other except for the row electrode selection pattern (FIGS. 4A and 5A) so that the following description is given with reference to FIG. 4 only, although it holds true of the case of FIG. 5.

FIGS. 4A, 4B, 4C, 4D, and 4E show the row electrode selection pattern (the orthogonal function A), the display pattern, the result of product-sum operation, the column electrode voltage pattern, and the value corresponding to the effective voltage, respectively. In the row electrode selection pattern (the orthogonal function A) as shown in FIG. 4A, 1 means +Vᵣ and −1 means −Vᵣ. The display pattern of FIG. 4B is data on four pixels in which 1 denotes an ON pixel and −1 denotes an OFF pixel. FIG. 4 presents a combination of all the possibilities upon the simultaneous selection of four rows, that is to say, 2⁴=16 types each of display pattern (FIG. 4B). and so forth are shown in the figure.

The result of MLA operation of FIG. 4C is the sum of the products obtained by multiplying the column vector by the display pattern for each cycle, corresponding to the result of “EXOR & add”.

Specifically, the row selection column vectors constituting the respective column vectors of the orthogonal function expressing the row electrode selection pattern (FIG. 4A) are each multiplied by each display data (vector) of the same column electrode as one of the row vectors of the display pattern (FIG. 4B) to obtain the products of the corresponding elements of the two relevant vectors, the table of the result of product-sum operation as shown in FIG. 4C thus given.

As shown in FIG. 4C, the numerical values appearing as the result of product-sum operation are ±4, ±2, and 0. The table of the column electrode voltage pattern of FIG. 4D is obtained by replacing the values −4, −2, 2, and 4 with 2, 1, −1, and −2, respectively.

The value corresponding to the effective voltage of FIG. 4E is obtained by adding the column electrode voltage pattern for each cycle in accordance with the value (−1 or 1) of the row electrode selection pattern (the orthogonal function A) as shown in FIG. 4A. More specifically, the value corresponding to the effective voltage is obtained by adding the column electrode voltage pattern as such when the value of the row electrode selection pattern is −1, or adding the column electrode voltage pattern after its polarity reversal when the value of the row electrode selection pattern is 1. After all, if each row of the row electrode selection pattern (FIG. 4A) is multiplied by each row of the column electrode voltage pattern (FIG. 4D) to obtain the products of the corresponding elements of the two relevant rows and sum them, the resultant sum is considered as a value corresponding to the effective voltage after being reversed in sign.

It is seen by comparing the display pattern (FIG. 4B or 5B) with the value corresponding to the effective voltage (FIG. 4E or 5E) that every ON pixel carries the same effective voltage of value 2 while every OFF pixel carries the same effective voltage of value −2 in either of the two cases, one illustrated by FIG. 4 where the orthogonal function A is used and the other illustrated by FIG. 5 where the orthogonal function B is used. This indicates that the voltage averaging is established in either case.

If the orthogonal function A or the orthogonal function B is used by itself, a specified one among the four rows (AC1 or BC3) brings about a brighter or darker representation. Such phenomenon is considered as so-called “COM stripes” as the brightness unevenness.

On the other hand, bias concentration occurs whenever the value 2 or −2 appears in the column electrode voltage pattern, which is recognized as a periodical variation in brightness if the operating frequency is low. Under a drive system as conventional, such variation in brightness is so conspicuous as to look like jitter in brightness when representation is carried out in one and the same state in a large portion of a display screen.

In contrast, the bias concentration as well as the COM stripes are eliminated in this embodiment. It is evident from a comparison between the case illustrated by FIG. 4 where the orthogonal function A is used and that illustrated by FIG. 5 where the orthogonal function B obtained by rotating the rows of the function A by one is used that the column electrode voltage pattern differs from one case to the other even though the display data is the same. Thus in this embodiment, the variation or jitter in brightness is made uniform (compensated) with time in one display cycle by allowing each of the two different orthogonal functions A and B to loop back in one display cycle, resulting in the elimination of the COM stripes and the bias concentration.

As described above, in this embodiment, the row selection time period is divided into two parts and the display cycle is completed by allowing both the orthogonal function A and the orthogonal function B (obtained by shifting the rows of the function A by one) to loop back. In consequence, the column vector rotation is exerted concurrently with the row vector rotation, making it possible to represent an image of high quality with no display unevenness or jitter.

Next, as a second embodiment of the method according to the present invention, an example of the simultaneous drive system for seven rows (FLA7 drive system) using the vector rotation of an orthogonal function with seven rows and eight columns is described as below.

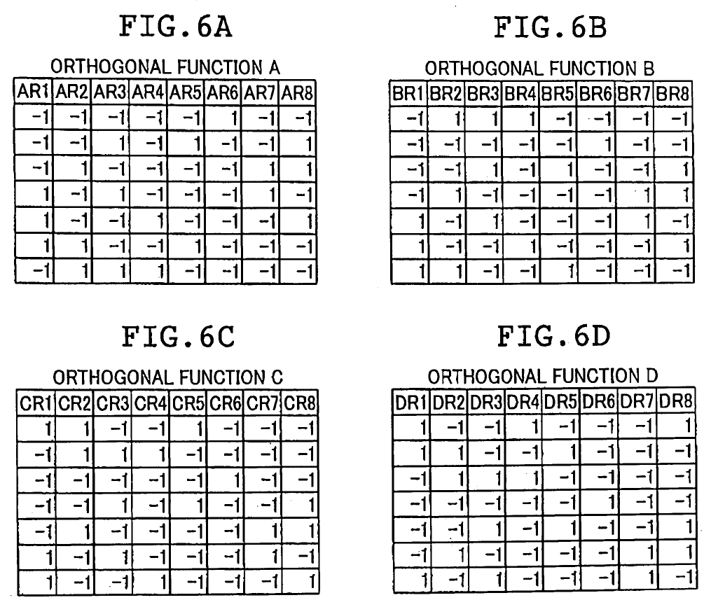

FIGS. 6A to 6D each show an example of the 7×8 orthogonal matrix expressing the orthogonal function used in this embodiment. It should be noted that the orthogonal matrices as shown are denoted by the characters A, B, C and D, respectively, and the orthogonal functions expressed by the matrices as well. Each of the matrices A to D is a so-called orthonormal matrix, in which the product of the matrix in itself and its transpose is an integral multiple of the unit matrix. The matrices B to D are each obtained by rotating the row vectors of the matrix A. Specifically, the matrix B is obtained by the one-row rotation of the matrix A, the matrix C by the two-row rotation thereof, and the matrix D by the three-row rotation thereof.

The idea of the simultaneous drive system for seven rows is basically identical to that of the simultaneous drive system for four rows of the above first embodiment. The following description is given concerning an example where four different orthogonal functions, namely the function A and the functions B to D each obtained by rotating the row vectors of the function A, are used and the row selection time period is divided into four parts, with one display cycle (for one frame) being completed in eight fields.

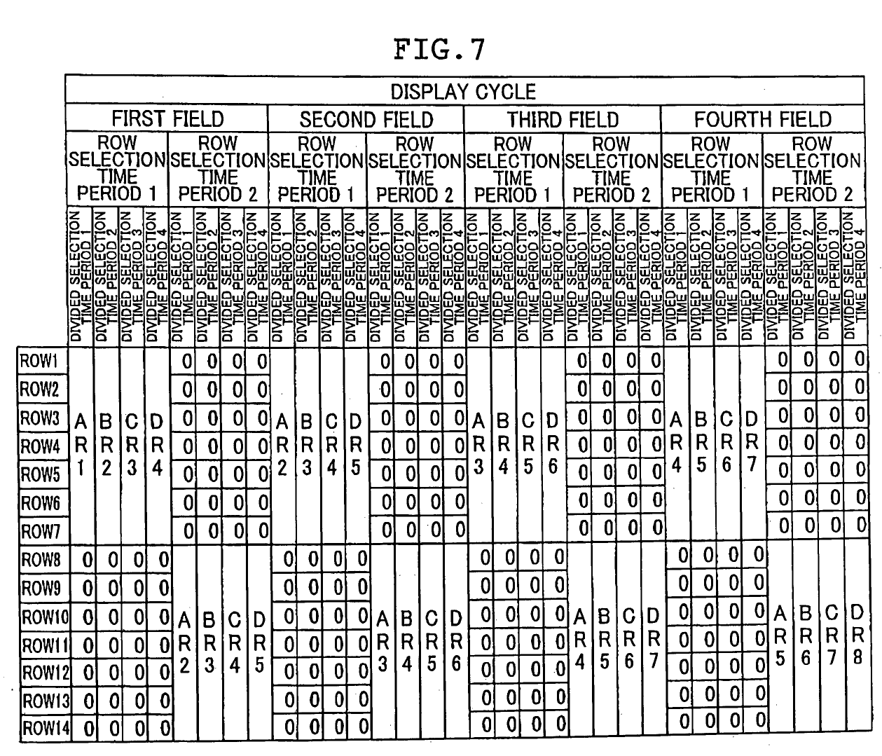

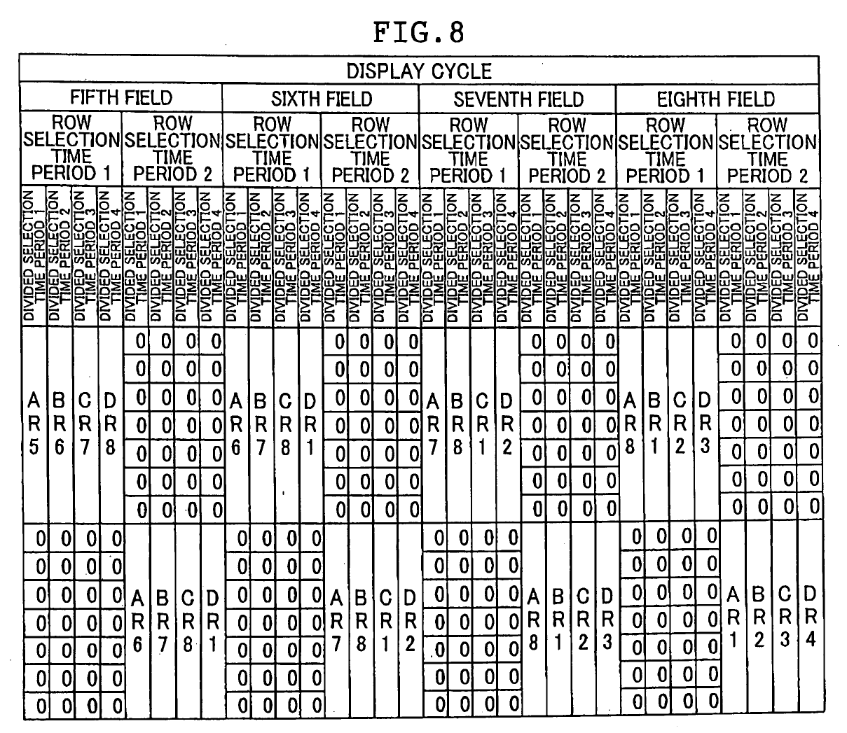

FIGS. 7 and 8 present together the outline of the simultaneous drive system for seven rows of this embodiment. The first to fourth fields of a display cycle are shown in FIG. 7 and the fifth to eighth fields of the same cycle in FIG. 8.

In the first field as shown in FIG. 7, the first column vector AR1 of the orthogonal function A, the second column vector BR2 of the orthogonal function B, the third column vector CR3 of the orthogonal function C, and the fourth column vector DR4 of the orthogonal function D are applied to the divided selection time periods 1 to 4 obtained by dividing the row selection time period 1, respectively.

Similar procedures are followed for the second to eighth fields as shown in FIGS. 7 and 8. Specifically, with respect to each field, any one of the column vectors AR1 to AR8 of the orthogonal function A is applied to the divided selection time period 1, any one of the column vectors BR1 to BR8 of the orthogonal function B to the divided selection time period 2, and so forth so that the column vectors of each of the orthogonal functions A to D may loop back in the display cycle as shown.

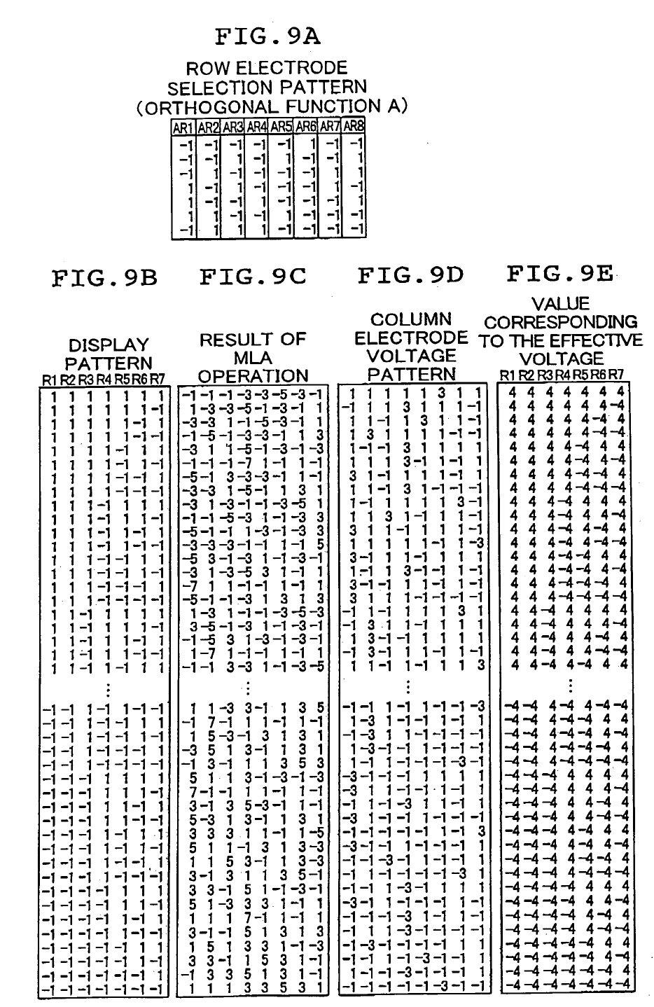

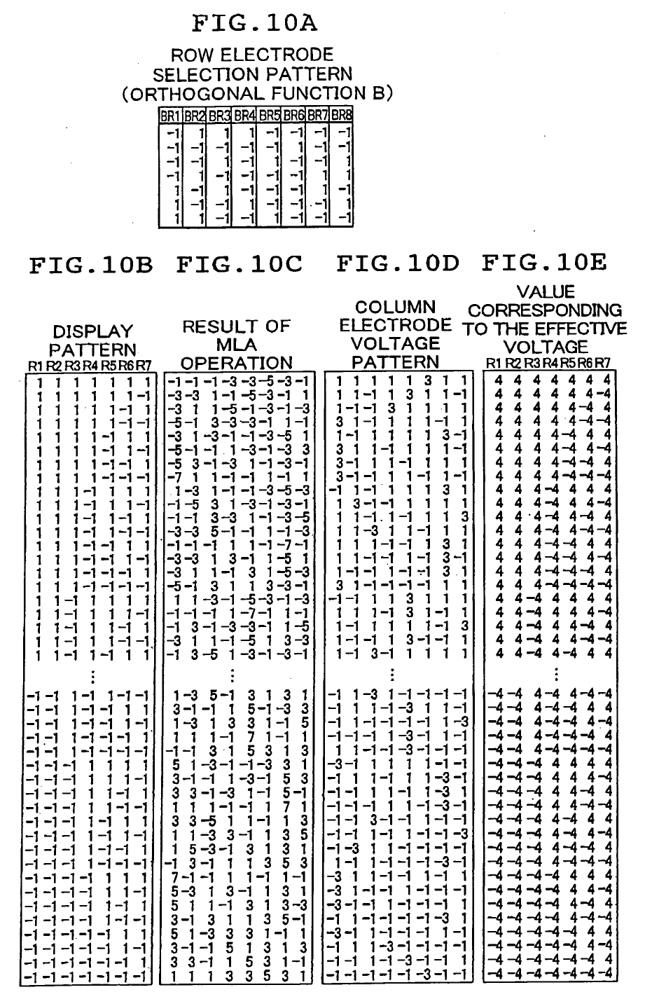

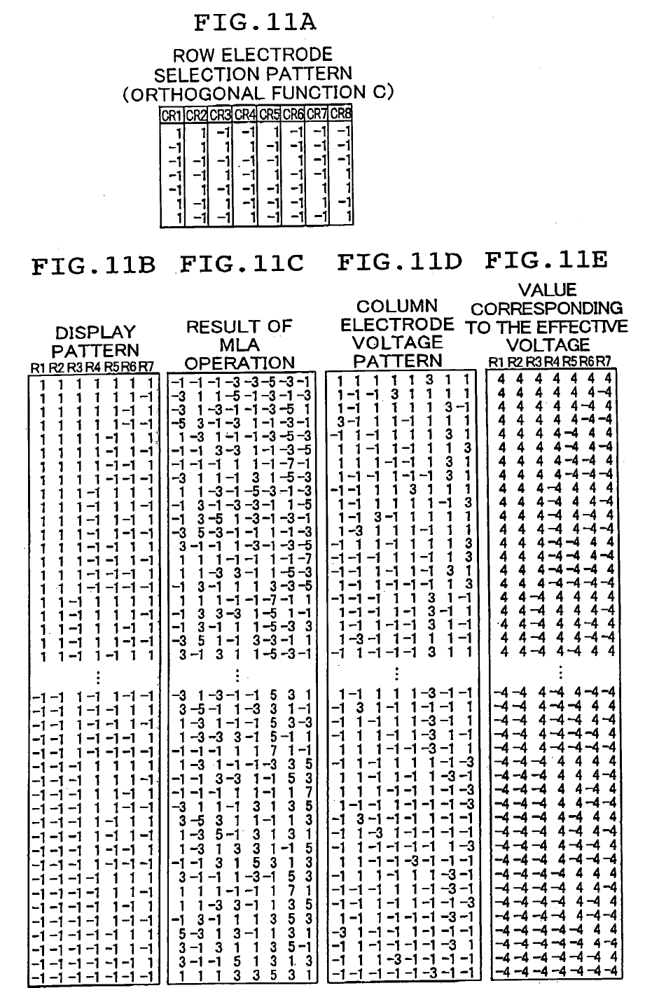

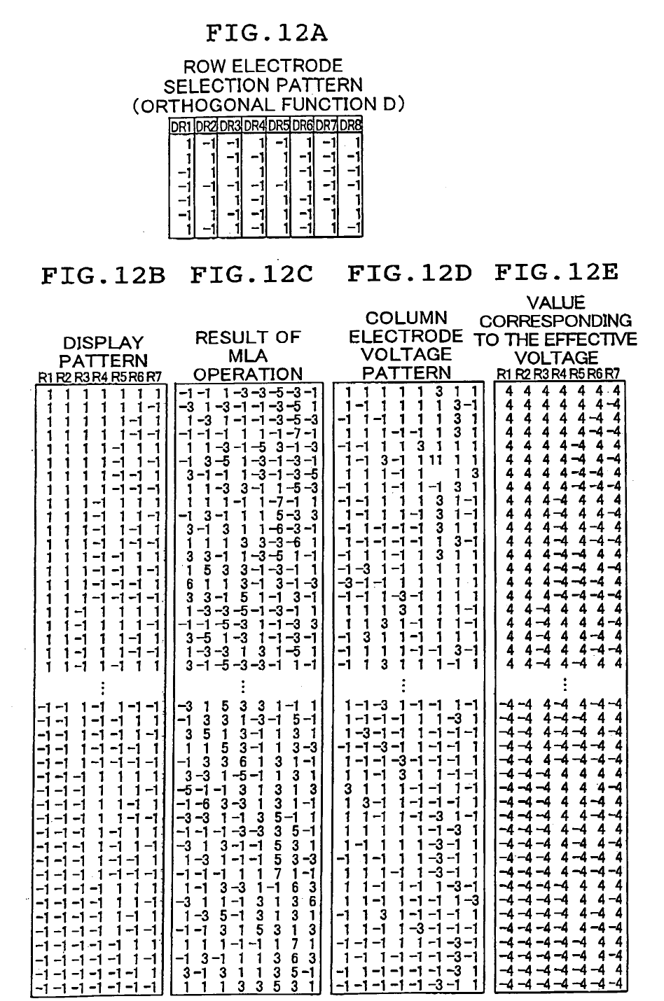

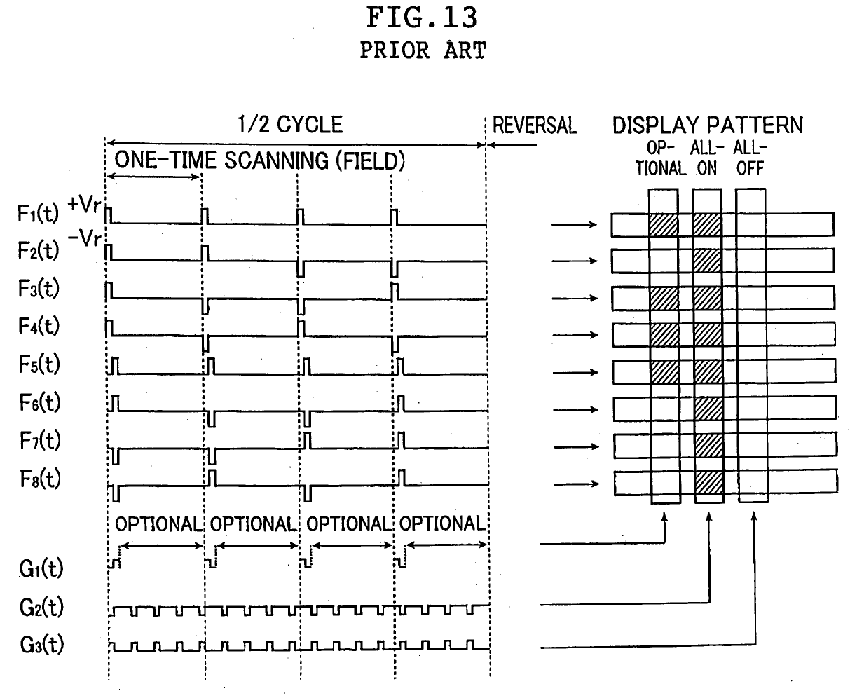

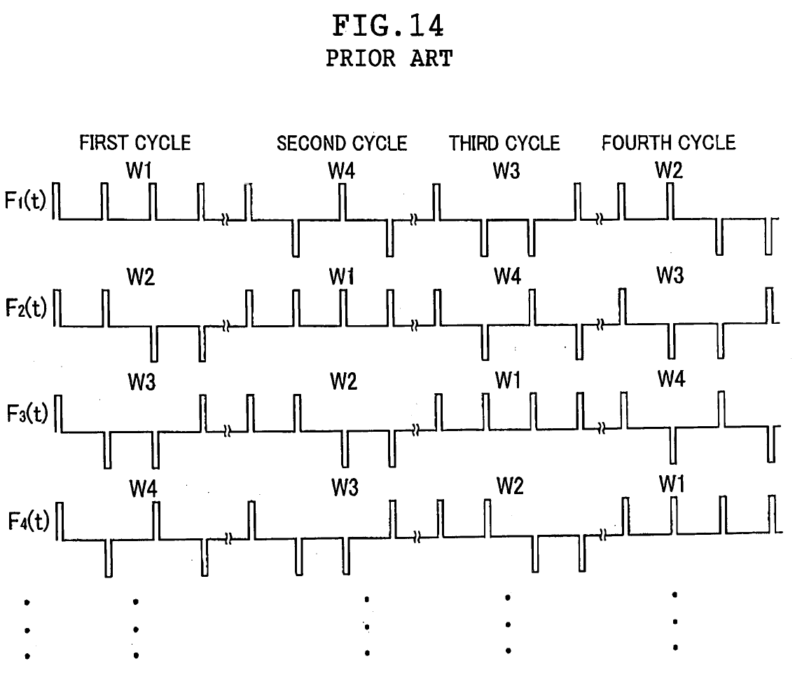

FIGS. 9 to 12 each represent an practical example of the simultaneous driving of seven rows. FIG. 9 illustrates the case where the orthogonal function A of FIG. 6A is used; FIG. 10 the case where the orthogonal function B of FIG. 6B is used; FIG. 11 the case where the orthogonal function C of FIG. 6C is used; and FIG. 12 illustrates the case where the orthogonal function D of FIG. 6D is used.

In each of FIGS. 9 to 12, the column electrode voltage pattern (FIG. 9D, 10D, 11D, or 12D) is obtained as a result of the conversion of the eight values (±1, ±3, ±5, and ±7) appearing in the result of MLA operation into four values (±1 and ±3) by replacing −7 and −5 with 3, −3 and −1 with 1, 1 and 3 with −1, as well as 5 and 7 with −3.

The simultaneous driving of seven rows is no more described because it is analogous to the simultaneous driving of four rows as described before in its details.

Also in this embodiment, it is seen with respect to each of the four cases illustrated by FIGS. 9 to 12 by comparing the display pattern (FIG. 9B, 10B, 11B, or 12B) with the value corresponding to the effective voltage (FIG. 9E, 10E, 11E, or 12E) that every ON pixel carries the same effective voltage of value 4 while every OFF pixel carries the same effective voltage of value −4. This indicates that the voltage averaging is established in any of the four cases. Moreover, the column electrode voltage pattern differs among the cases.

COM stripes are ameliorated by allowing each of the four different orthogonal functions to loop back in one display cycle.

Taking notice of the column electrode voltage pattern when the display data is of an “all 1” type and when it is of an “all 0” type (data value 0 being denoted by −1 in the figures), the value 3 or −3 appears in the column electrode voltage pattern in connection with the sixth column vector of the orthogonal function used, whatever is the function, the orthogonal function A, B, C, or D. In other words, bias concentration occurs with any of the orthogonal functions A to D used by itself.

In the present invention, the column vectors of different orthogonal functions are applied to one and the same row selection time period, as described above. Consequently, bias concentration.is made uniform with time and jitter in brightness is inconspicuous even if the operating frequency is low.

The foregoing description is given concerning the simultaneous drive systems for four rows and for seven rows as examples of the MLA drive system. The method of the invention is in no way limited to the above two systems but may be applied to any type of MLA drive system.

The process for applying the column vectors (AR, BR, CR, and DR) is not limited to such as described above. Any process may be employed as appropriate, that is to say, a process may be employed which seems to be most appropriate as a result of observation of a represented image.

The row selection time period may be divided into any appropriate number of parts.

Finally, while a few different orthogonal functions can be obtained by rotating the rows of the orthogonal function A, any type of orthogonal function may be used as the basic function whose rows are to be rotated.

As evident from the foregoing description, it is possible with the method of the invention to eliminate the bias concentration and the COM stripes, both specific to the MLA drive system, to remarkably improve the quality of a represented image.

In the case of representing a still image or a slow-motion image, power consumption can be reduced because the display quality will be less deteriorated if the operating frequency is decreased.

The circuit for implementing the method of the invention has an extremely reduced size because the method carries out exclusively the scan for selection of the column vectors of an orthogonal function for each divided selection time period and the bitwise rotation of the selected column vector in accordance with the divided selection time period in question.

In the method of the invention, the row selection time period is divided into parts which are smaller in number than the column vectors of an orthogonal function. Consequently, the column electrode driving frequency can be decreased and the display quality improved.

Moreover, the selection-equivalent orthogonal functions are made equal or smaller in number to or than the divided selection time periods, which makes it possible to shorten the display cycle so as to decrease the operating frequency and reduce power consumption.

Although the method and the apparatus for driving passie matrix liquid crystal on a multiline-addressing basis, and the liquid crystal panel of the present invention have been described in detail as above, the present invention is not limited to the above embodiments. It is apparent that various modifications and changes may be made without departing from the scope of the present invention.

As described above in detail, according to the present invention, the bias concentration and the COM stripes as a horizontal stripe-like unevenness in brightness, both specific to the MLA drive system, can be eliminated so as to improve the display quality and, in addition, reduction in power consumption and circuit downsizing can be achieved.

What is claimed is:

1. A multiline addressing drive method for passive matrix liquid crystal by using an orthogonal function to simultaneously drive a plurality of rows of the passive matrix liquid crystal as one block of rows, comprising steps of:
allocating rotated column vectors of a plurality of selection-equivalent orthogonal functions obtained by rotating row vectors of one orthogonal function which is used as a selection pattern for simultaneously selected row electrodes to a plurality of divided selection time periods obtained by dividing a selection time period of one of said simultaneously selected row electrodes, respectively; and
allowing the column vectors of every said selection-equivalent orthogonal function to loop back in time series with respect to said one block.

2. The multiline addressing drive method according to claim 1, wherein said divided selection time periods are smaller in number than said column vectors of said orthogonal function.

3. The multiline addressing drive method according to claim 1, wherein said plurality of selection-equivalent orthogonal functions are equal in number to or smaller in number than said divided selection time periods.

4. A multiline addressing drive method for passive matrix liquid crystal by using an orthogonal function to simultaneously drive a plurality of rows of the passive matrix liquid crystal as one block of rows, comprising steps of:
scanning column vectors of said orthogonal function in each of a plurality of divided selection time periods obtained by dividing a selection time period of one of simultaneously selected row electrodes to select said column vectors; and
rotating said column vectors bitwise in accordance with said divided selection time periods.

5. The multiline addressing drive method according to claim 4, wherein said divided selection time periods are smaller in number than said column vectors of said orthogonal function.

6. A multiline addressing drive apparatus for passive matrix liquid crystal, which drives said passive matrix liquid crystal by a multiline addressing drive method for the passive matrix liquid crystal by using an orthogonal function to simultaneously drive a plurality of rows of the passive matrix liquid crystal as one block of rows, comprising steps of:
allocating rotated column vectors of a plurality of selection-equivalent orthogonal functions obtained by rotating row vectors of one orthogonal function which is used as a selection pattern for simultaneously selected row electrodes to a plurality of divided selection time periods obtained by dividing a selection time period of one of said simultaneously selected row electrodes, respectively; and
allowing the column vectors of every said selection-equivalent orthogonal function to loop back in time series with respect to said one block.

7. A multiline addressing drive apparatus for passive matrix liquid crystal, which drives said passive matrix liquid crystal by a multiline addressing drive method for the passive matrix liquid crystal by using an orthogonal function to simultaneously drive a plurality of rows of the passive matrix liquid crystal as one block of rows, comprising steps of:
scanning column vectors of said orthogonal function in each of a plurality of divided selection time periods obtained by dividing a selection time period of one of simultaneously selected row electrodes to select said column vectors; and
rotating said column vectors bitwise in accordance with said divided selection time periods.

8. A liquid crystal panel driven by a multiline addressing drive method for passive matrix liquid crystal by using an orthogonal function to simultaneously drive a plurality of rows of the passive matrix liquid crystal as one block of rows, comprising steps of:
allocating rotated column vectors of a plurality of selection-equivalent orthogonal functions obtained by rotating row vectors of one orthogonal function which is used as a selection pattern for simultaneously selected row electrodes to a plurality of divided selection time periods obtained by dividing a selection time period of one of said simultaneously selected row electrodes, respectively; and
allowing the column vectors of every said selection-equivalent orthogonal function to loop back in time series with respect to said one block.

9. A liquid crystal panel driven by a multiline addressing drive method for passive matrix liquid crystal by using an orthogonal function to simultaneously drive a plurality of rows of the passive matrix liquid crystal as one block of rows, comprising steps of;
scanning column vectors of said orthogonal function in each of a plurality of divided selection time periods obtained by dividing a selection time period of one of simultaneously selected row electrodes to select said column vectors; and
rotating said column vectors bitwise in accordance with said divided selection time periods.
